(19) United States
(12) Patent Application Publication
(10) Pub. No.: US 2017/0095891 A1
(43) Pub. Date: Apr. 6, 2017

(54) Lead-free composite solder

(71) Applicant: Iowa State University Research Foundation, Inc., Ames, IA (US)

(72) Inventors: Iver E. Anderson, Ames, IA (US); Stephanie M. Choquette, Ames, IA (US); Kathlene N. Reeve, Lafayette, IN (US); Joel L. Harringa, Ames, IA (US)

(73) Assignee: Iowa State University Research Foundation, Inc.

(21) Appl. No.: 15/330,496

(22) Filed: Sep. 28, 2016

Related U.S. Application Data
(60) Provisional application No. 62/284,487, filed on Oct. 1, 2015.

(51) Int. Cl. B23K 35/26; C22C 13/00; C22C 9/02; H01B 1/02; B23K 35/02

(52) U.S. Cl. CPC B23K 35/262; H01B 1/02; B23K 35/025; C22C 9/02; C22C 13/00

(57) ABSTRACT

A composite solder material for mixing with flux to provide a composite solder paste. The solder material includes a mixture having a relatively low melting solder or solder-forming powder and a relatively high melting Ni-containing reinforcement powder. Use of the solder paste under solder reflow conditions produces a high melting point solder joint by liquid phase diffusion bonding wherein a Ni-stabilized high temperature hexagonal (Cu,Ni)₆Sn₅ phase is the solder joint matrix that bonds together the Ni-containing reinforcement powder particles. With each reflow cycle, more of the low melting solder or solder-forming powder is converted to the hexagonal (Cu,Ni)₆Sn₅ matrix phase, raising the final melting temperatures of the post-processed solder joint and giving the solder the ability to withstand higher Joule-heating, all while improving resistance to solder joint cracking.

### RELATED APPLICATION

This application claims benefits and priority of U.S. provisional application Ser. No. 62/284,487 filed Oct. 1, 2015, the entire disclosure of which is incorporated herein by reference.

### CONTRACTUAL ORIGIN OF THE INVENTION

This invention was made with government support under Grant No. DE-AC02-07CH11358 awarded by the U.S. Department of Energy. The government has certain rights in the invention.

### FIELD OF THE INVENTION

The present invention relates to a composite solder paste that includes a mixture of a solder or solder-forming powder and a Ni-containing reinforcement powder to produce a high melting point solder joint using liquid phase diffusion bonding and having a Ni-stabilized hexagonal (Cu,Ni)₆Sn₅ phase as the matrix phase that bonds together the reinforcement powder.

### BACKGROUND OF THE INVENTION

The development of high-temperature lead-free solders is becoming increasingly crucial for use in power electronics in the automotive, aerospace, military, and energy production industries [references 2,5]. The currently used typical high-temperature solders are Pb-5Sn (wt. %) or Pb-10Sn (wt. %) that melt around 300° C. A typical solder reflow cycle will have a peak reflow temperature 20° C. to 40° C. above the melting point of the solder; therefore, the current typical high temperature solder has a reflow temperature around 330° C. [references 8,13]. The operating temperatures of these solders are usually less than 250° C., but it is critical that the solder be able to survive hierarchical solder reflow throughout all stages of lower temperature reflow processing [reference 2].

With today's increased power pumping through electronics, higher operating temperatures can contribute to brittleness in solder joints by several mechanisms upon thermal cycling [references 8,10,11]. In the past, this cracking did not occur because the microstructures formed by lead and tin did not consist of any brittle intermetallic compounds, but now Pb use is becoming much more restricted due to RoHS [references 2,18,19].

There is a need for a lead-free version of these high-Pb solder alloys that can be used at equal or lower processing temperatures, but can still withstand high operating temperatures. For example, a lead-free version would have a lower melting temperature, so that the reflow temperature could also be lower, but that with the ability to evolve during low temperature reflow to a microstructure with high temperature stability. The lead-free version also would have acceptable mechanical properties that avoid brittle phases, which is a problem for several of the alternative solders, including another type of composite paste approach that uses pure Cu powder as a filler powder [reference 8]. Alloy cost should also be well within reasonable bounds, unlike the Au—Sn solder system that seems to meet some desirable characteristics, but certainly has a cost problem.

### SUMMARY OF THE INVENTION

The present invention provides a composite solder material for mixing with flux to provide a composite solder paste that meets the above need. The composite solder material includes a mixture of relatively low melting solder or solder-forming powder and a relatively high melting Ni-containing reinforcement powder that provides a source of Ni for incorporation into and stabilization of the high temperature (more ductile) hexagonal (Cu,Ni)₆Sn₅ phase upon cooling from reflow to room temperatures. The Ni-containing reinforcement powder may be present in the mixture in amounts to improve electrical conductivity across the joint.

The Ni-containing reinforcement powder can be present as a majority (50% by volume or more) of the metallic powders present to maximize conductivity improvement (and impact resistance) if a gas-based (e.g., formic-acid) fluxing approach is used on a blended powder (cold pressed) solder “wafer,” or more preferably as a minority (less than 50% by volume) to significantly reduce or eliminate porosity in the solder joint made with more conventional composite solder (liquid-based) paste material.

The present invention also provides a high melting point solder joint produced using the solder in a liquid phase diffusion bonding process and having the stabilized high temperature hexagonal (Cu,Ni)₆Sn₅ phase as a matrix phase with improved ductility that bonds together the Ni-containing reinforcement powder particles, which can provide improved electrical conductivity in the solder joint.

In practice of an illustrative embodiment of the present invention, liquid phase diffusion bonding transforms, with each reflow cycle, more of the low melting solder or solder-forming powder to the hexagonal (Cu,Ni)₆Sn₅ matrix phase, raising the final melting temperatures of the post-processed solder from 227 degrees C. to over 400 degrees C. and giving the solder the ability to withstand higher Joule-heating, all while improving resistance to solder joint cracking by eliminating the crack-promoting low temperature monoclinic Cu₆Sn₅ phase in the solder joint matrix.

Advantages and further details of the present invention will become more readily apparent from the following detailed description taken with the drawings which follow.

### BRIEF DESCRIPTION OF THE DRAWINGS

FIG. 1a is a schematic of the composite solder paste pursuant to the invention that joins two spaced Cu substrates. FIG. 1b is a schematic of the preliminary test model for the paste, where different Cu—X alloy substrates are used to simulate effects of X-containing reinforcement powder on joint microstructure.

FIG. 2 shows microstructures of SN100C on the four types of substrates shown in FIG. 1b, aged at 10 and 100 minutes, where horizontal lines in the intermediate gray regions indicate cracking (scale bar=20 km).

FIG. 3 illustrates the process of liquid phase diffusion bonding of Cu-10Ni powders and SN100C powders: In image 1, two types of powder are blended (low-melting tin alloy shown in light gray) and high-melting Cu-10Ni shown in black). In image 2, diffusion of Sn alloy into Cu-10Ni particles at points of contact during initial heating. In image 3, capillary liquid spreading of tin alloy upon melting is shown. In image 4, completion of isothermal solidification upon cooling is shown.

FIG. 4 is an SEM image that shows how the tin solder alloy diffuses into the surface of the reinforcement powder (the darkest regions of the microstructure), creating the Ni-stabilized (Cu,Ni)₆Sn₅. The circle is a location where residual tin resides.

FIG. 5 shows volume percent and relative size comparison of blended powders tested.

FIG. 6 shows a schematic setup of composite solder compact (left view), a schematic view of the setup within the box furnace (middle view), and a schematic view of the box furnace closed for experimentation (right view).

FIG. 7 shows time versus temperature plots representing average thermal cycles of each reflow temperature of 250° C., 275° C., and 300° C., respectively.

FIGS. 8a-8f show SEM micrographs for each combination of reflow time and temperature with a scale bar of 50 μm.

FIGS. 9a-9f show SEM micrographs for each combination of reflow time and temperature with a scale bar of 5 μm.

FIGS. 10a-10f show the average percent area of each phase measured for each reflow combination.

FIGS. 11a-11f show the average composition determined by EDS of each reflow combination where the vertical axis is atomic %.

FIG. 12 shows a double-sided LPDB joint microstructure produced using the composite paste described below. The ratio of powders in this blend was 24 vol. % Cu-10Ni:76 vol. % SN100C, before reflow. LPDB means liquid phase diffusion bonded.

FIG. 13 shows the reflow profile applied to each paste blend combination on the hot plate setup used to test the effect of particle size range of Cu-10Ni powder on joint porosity.

FIG. 14 shows images A-D of the matrix phase of the cross-sections for all four paste blends tested (Table 1).

### DETAILED DESCRIPTION OF THE INVENTION

The present invention provides a composite solder material for mixing with flux to provide a composite solder paste. The composite solder material includes a mixture of relatively low melting solder or solder-forming powder and a relatively high melting Ni-containing reinforcement powder. The Ni-containing reinforcement powder provides a source of Ni for incorporation into and stabilization of the high temperature hexagonal (Cu,Ni)₆Sn₅ phase upon cooling to room temperature from reflow temperature(s).

In an illustrative embodiment of the present invention, the low melting point solder or solder-forming powder can comprise a solder alloy, such as a low melting eutectic or near-eutectic Sn—Cu solder alloy, other solder alloys containing Sn, and/or metallic Sn so as to form the high temperature hexagonal (Cu,Ni)₆Sn₅ phase under reflow conditions. The selected composition of the solder or metallic Sn takes into account any expected alloy element uptake from the Ni-containing reinforcement powder and/or components being soldered, such as uptake of Cu and/or Ni from PCB pads, etc.

In another illustrative embodiment, the Ni-containing reinforcement powder can comprise alloy powder particles that contain a metal such as one or more of Cu, Co, and others alloyed with Ni, provided the reinforcement powder has a higher melting point than the solder or solder-forming powder. The reinforcement powder preferably comprises Cu—Ni alloy powder. A particular embodiment of the present invention employs Cu-5-15 weight % Ni alloy powder particles to this end. During reflow conditions, liquid phase diffusion bonding between the two powders results in the Ni stabilizing agent being incorporated in solid solution in the hexagonal (Cu,Ni)₆Sn₅ phase in an amount to stabilize the phase from reflow to room temperature. The selected composition of the reinforcement powder can take into account effects of any alloy element uptake from the components being soldered.

In still another illustrative embodiment of the present invention, the reinforcement powder is present as about 60 to about 90% by volume of the metallic powders present in the mixture sans flux. Preferably, in this embodiment, the reinforcement powders are present in an amount of about 60 to about 80% by volume of the mixture. An even more preferred amount of reinforcement powder is about 70% by volume of the mixture.

In a further embodiment of the present invention, the Ni-containing reinforcement powder can be present as a minority (less than 50% by volume) of the powder mixture sans flux to significantly reduce or eliminate porosity in the solder joint made with conventional composite solder (liquid-based) paste material. A preferred amount of the reinforcement powder is from about 10% by volume to less than 50% by volume, such as about 10 to about 40 volume % or about 10 to about 30 volume % of the mixture.

In still a further illustrative embodiment of the present invention, the reinforcement powder is employed in a particle size range that is similar to (substantially the same as) or larger than the particle size range of the solder or solder-forming powders in order to minimize particle surface area for wetting by the solder or solder-forming powder and to retain the solid reinforcement powder particles themselves in the final solder joint microstructure.

Practice of the present invention involves producing a high melting point solder joint produced by using the composite solder paste in a reflow liquid phase diffusion bonding process and having the stabilized high temperature hexagonal (Cu,Ni)₆Sn₅ phase as the matrix phase that bonds together the Ni-containing reinforcement powder particles, which may provide a high electrical conductivity network in the solder joint. The high melting point solder joint is free of the undesirable monoclinic Cu₆Sn₅ (η′) phase that can cause solder joint cracking upon cooling from the reflow temperature to room temperature as explained below.

In practice of the present invention, liquid phase diffusion bonding transforms, with each reflow cycle, more of the low melting solder or solder-forming powder to the hexagonal (Cu,Ni)₆Sn₅ matrix phase, raising the final melting temperatures of the post-processed solder from 227 degrees C. to about 400 degrees C. and giving the solder the ability to withstand higher Joule-heating, all while improving resistance to solder joint cracking by eliminating the crack-promoting, low temperature monoclinic Cu₆Sn₅ (η′) phase in the solder joint matrix at room temperature.

### Preliminary Example

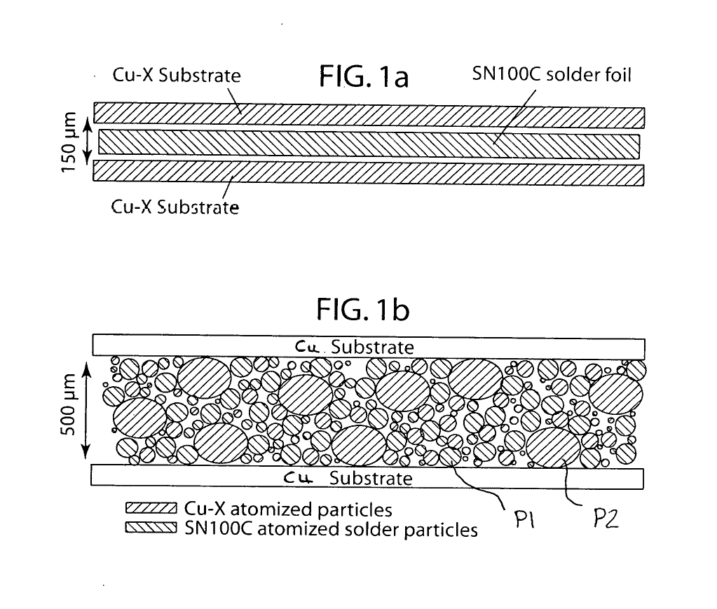

FIG. 1a is a schematic of the composite solder paste pursuant to the invention between two Cu substrates where the solder paste includes a mixture of relatively low melting solder or solder-forming powder particles P1, a relatively high melting Ni-containing reinforcement powder particles P2 of larger size and greater volume percent, and flux wetting the powders and in the interstices. The Cu substrates represent and include, but are not limited to, PCB pads, lead wires, lead frames, electronic components, and the like, which may be Cu or Ni-coated Cu, or other types.

FIG. 1b is a schematic of an initial model of this solder paste system that allowed selection of comparison element X, such as Cu, Ni, Zn, and Sn, to alloy into the Cu reinforcement particles in order to demonstrate which element X would achieve the advantages of the invention. The Cu—X alloy substrates simulate the reinforcement powder.

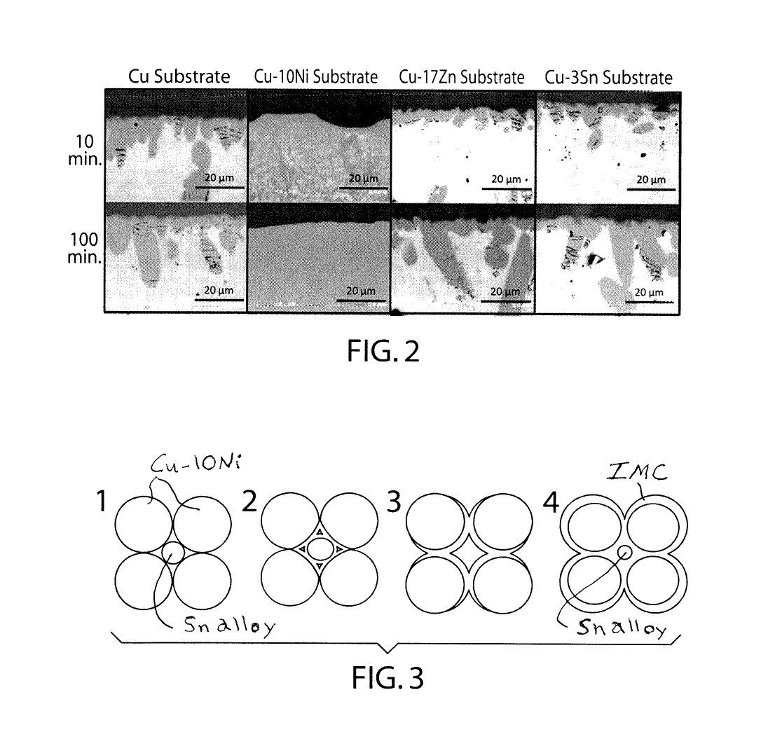

A series of high temperature (330° C.) reflow tests that were coupled to extended thermal aging at 250° C. were conducted with several types of Cu-alloy substrates in contact with a single type of Sn—Cu—Ni solder; namely, Nihon Superior's SN100C (Sn-0.65% Cu-0.05% Ni-60 ppmw Ge solder % in weight %) available from Nihon Superior (NS Building, 1-16-15 Esaka-Cho, Suita City, Osaka 564-0063, Japan) (see FIG. 2). This test design was intended to simulate an aggressive test of “drop-in” application of the composite paste formulations, with much more exposure to very high use temperature (250° C.) than expected in typical solder reflow applications.

The model joint sample microstructures shown in FIG. 2 show that the use of the Cu-10Ni substrate produced the only crack-free IMC matrix during the aging treatments, as well as the ability to rapidly, uniformly spread the IMC matrix across the joint gap. The ability of a local source of excess Ni (from the Cu-10Ni substrate) in the model joint samples to promote rapid uniform growth of the desired IMC matrix phase across the joint was unexpected and appeared to be very beneficial to achievement of a substitute Pb-free solder system.

To explain in more detail, FIG. 2 shows the microstructures seen during conceptual testing of the modeled composite solder system where the solder joint substrates (shown in the top off each micrograph in FIG. 2) would become the pre-alloyed powder filler phase that is bonded by a low melting Pb-free solder alloy (Sn—Cu based) matrix phase. The intermediate darker gray phase/region in each case is the IMC that forms during soldering. Cracking occurs in the intermetallic compound (IMC) with pure Cu and the other Cu-alloy types, except for Cu—Ni. The (Cu,Ni)₆Sn₅ IMC growth front in the image second from the left is much more dispersed in its advance and became fully transformed, compared to the other IMCs and has no cracking. With 100 minutes of aging, the (Cu,Ni)₆Sn₅ phase became a single phase across the entire solder joint in FIG. 2f, albeit with a tendency of joint centerline cracking (not shown in FIG. 2) at these long aging times at 250° C. The composition of this Ni-stabilized (Cu,Ni)₆Sn₅ IMC phase has been shown to vary between 1 and 12 at % Ni, while still being effective at reducing the brittleness of the IMC phase [reference 10]. The most preferred stoichiometry was determined to be Cu_{5.5}Ni_{0.5}Sn₅.

With respect to phase stabilization, on the Cu—Sn phase diagram, Cu₆Sn₅ is seen existing as two allotropic phases. One allotrope is the high temperature hexagonal Cu₆Sn₅ (q) and the other is the low temperature monoclinic Cu₆Sn₅ (η′). The fact that the interfacial (Cu)₆Sn₅ (η′) IMC forms during reflow without excessive porosity shows that there is adequate wetting and bonding of all of the substrate alloys by the solder alloy, but the tendency for cracking of the resulting IMC in the non-Ni solder joints of FIG. 2 appears to be linked to the allotropic phase transformation on cooling to Cu₆Sn₅ (η′). For example, If the phase transformation to monoclinic on cooling is allowed to occur, it can cause cracking in newly formed Cu₆Sn₅ η′-phase that is near an external surface in the joint due to a volume change of about 2.15% that causes stress in the intermetallic layers, which is relieved by layered cracking, as seen in FIG. 2. In addition to removing an abrupt volume change from the allotropic transformation, extra slip systems (and ductility) result from retaining the hexagonal allotrope, making this hexagonal phase much more attractive and preferred for use as the solder joint matrix.

The following Detailed Examples are offered to further illustrate the present invention without limiting the scope of the invention.

### Detailed Examples

These Examples illustrate blending together two types of Ni-containing powder, gas-atomized Cu-10Ni (wt. %) powder particles and atomized solder powder of Nihon Superior's SN100C (Sn-0.65% Cu-0.05% Ni-60 ppmw Ge) to form a composite solder blend.

Before going through the compounding of a full paste sample, the intended dual-powder composite model was tested as a porous compact that was infiltrated by a typical flux described below for the SN100C solder and reflowed to form simulated test joints. These test joints were useful for microstructure evaluation to study the effects of varying reflow time and temperature on the resulting joint microstructure. The test joints were to demonstrate that the composite solder joint microstructure could benefit from nickel additions through the phenomena of liquid-phase diffusion bonding (LPDB). The LPDB process takes advantage of the relatively low liquidus temperature of the SN100C solder powder combined with the relatively high diffusion kinetics of the Ni addition in both powders to rapidly form ductile intermetallic compound [(Cu,Ni)₆Sn₅] that would serve as a strong, crack-free matrix phase for the high electrical conductivity of the resulting Cu-10Ni particle network.

### Experimental Procedure Composite Model Preparation:

Model composite paste solder joints were produced with a variety of blends of gas-atomized Cu-10Ni (wt %) powder and Sn-0.7% Cu-0.05% Ni+Ge, Nihon Superior SN100C (wt. %) solder powder, according to the combinations listed in FIG. 5. The Cu-10Ni powders were of the size range 25-32 μm (similar to Type 4 solder powder) and the SN100C powders were of the size range 5-15 pm (Type 6). The powder size (as schematically illustrated in FIG. 5) of the Cu—Ni was chosen to be larger than the SN100C, so as to minimize surface area for wetting and minimize IMC (intermetallic compound) formation. The powders were dehydrated to reduce clumping for 1 hour at 100° C. and blended with a multiple axis blender for approximately 20 minutes. The blended powders were then compressed, using a cold isostatic press (CIP), into 5 mm diameter rods to a density of 73%. The resulting compacted powder rods were cut into approximately two millimeter discs, and leveled with 320 grit paper for use as solder compacts. The chosen density allowed the CIP'ed powder compacts to soak up flux (Superior No. 99-25.39, a J-STD 002C RMA type of flux) in order to imitate a solder paste. Flux was obtained from Superior Flux & Manufacturing Co., 6615 Parkland Blvd., Cleveland, Ohio 44139, USA.

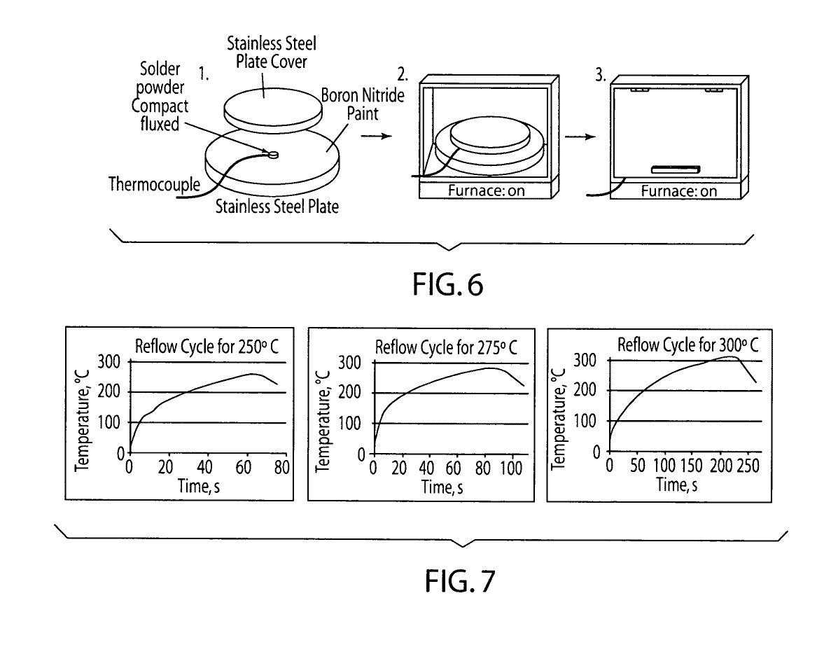

The flux-soaked powder compacts were then tested using the setup illustrated in FIG. 6. The compacts were placed between boron-nitride coated stainless steel plates to optimize the heating of the solder. The setup was located in a furnace and tested with peak reflow temperatures of 250° C., 275° C., and 300° C., along with peak reflow times of 30 and 60 seconds.

FIG. 7 contains the recorded reflow cycles of the experiment, which match well with reflow cycles from literature [references 11, 20]. The solder paste models were cooled at about 1.5° C. per second by placing them on a copper block at room temperature to cool.

At random, of the six (6) reflow combinations, four were repeated three times and two were repeated twice. At least sixteen micrographs of the same magnification were taken and analyzed for each tested sample. After analysis, the best ratio of powders was determined to be 70 volume percent Cu-10Ni with 30 volume percent SN100C. This combination resulted in the best continuous Cu—Ni conductive network while not sacrificing the SN100C needed to wet the Cu-10Ni particles together to form the desired Ni-stabilized hexagonal (Cu,Ni)₆Sn₅ IMC matrix phase. Therefore, the following results are for this particular model containing 70 volume percent Cu-10Ni.

### Results:

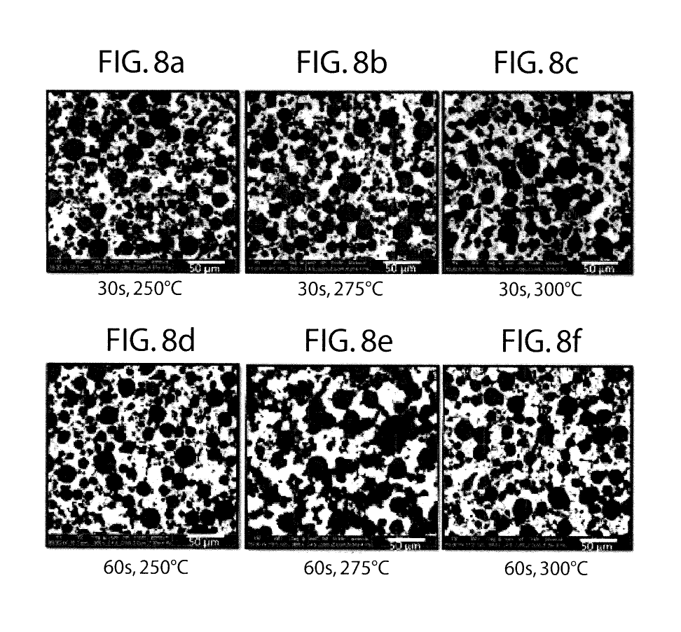

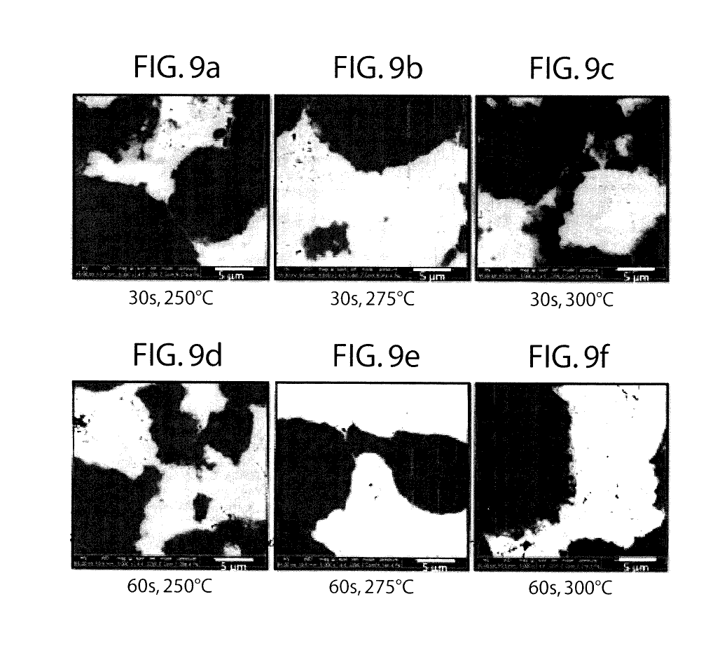

FIGS. 8a-8f contain the resulting micrographs for each combination of reflow time and temperature tested. From these images, the microstructures look very similar to each other. Therefore, the same micrographs are shown in FIGS. 9a-9f at a higher magnification. The darkest regions are the Cu—Ni, the intermediate gray phase is the IMC, and the lightest phase is the residual SN100C matrix. Again, it is hard to differentiate the microstructures just by looking at them. What is apparent from the microstructures is the lack of cracking in the hexagonal (Cu,Ni)₆Sn₅ IMC matrix phase or any significant Kirkendall voids that would be located in the residual Sn alloy regions.

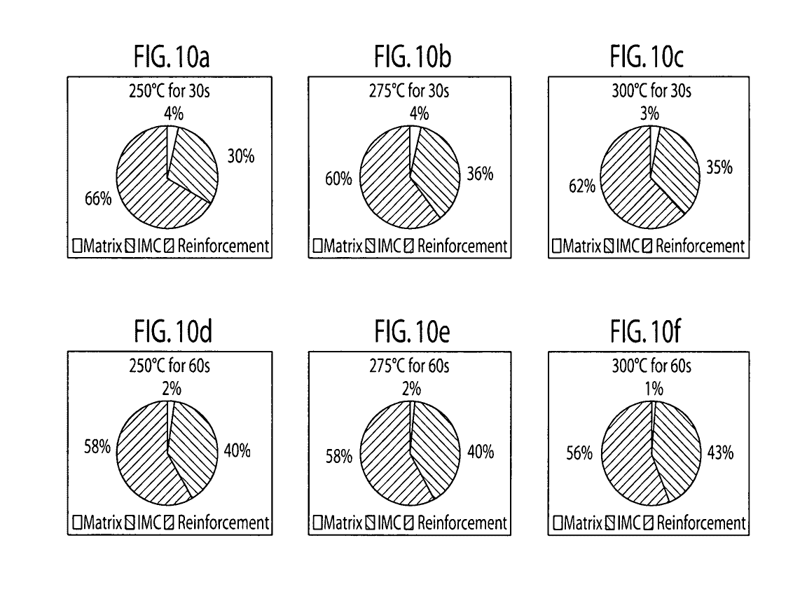

The image analysis of sixteen micrographs per sample gave the averages shown in FIGS. 10a-10f for the area percent of the phases present in the average microstructure. With shorter reflow cycles or higher reflow temperatures, there was a slightly larger content of residual tin alloy left in the microstructures. This phase melts upon reheating to above 227° C., but should then continue its diffusion-promoted transformation into the (Cu,Ni)₆Sn₅ IMC with longer time or with each reflow re-cycle. As shown in the pie charts, the amount of residual tin can be decreased with longer reflow cycles or higher reflow temperatures, if desired. However, in addition, longer cycling decreases the amount of reinforcement powder. Therefore, in order to maximize the content of the highest conducting phase Cu-10Ni, the shorter reflow times are recommended for this composite solder paste.

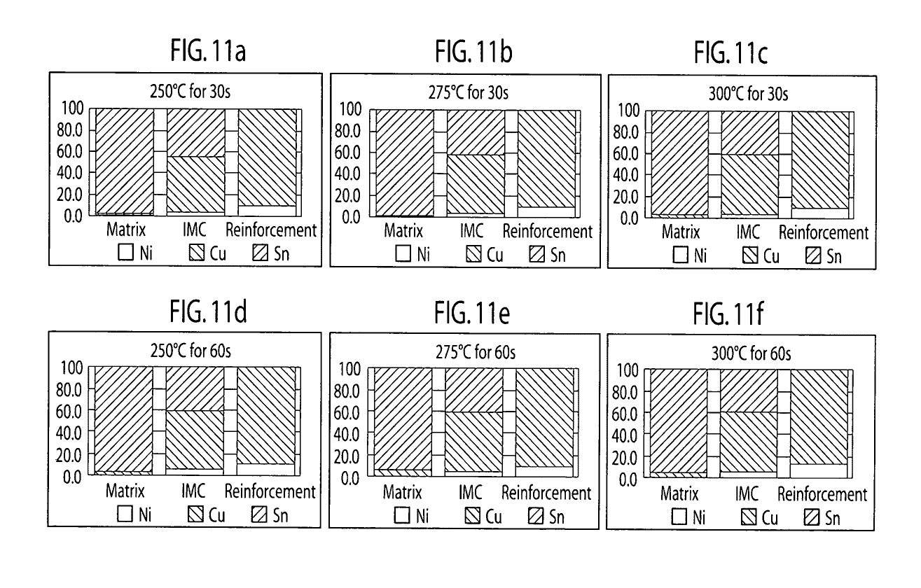

FIGS. 11a-11f show the results of EDS for each reflow combination. These results stayed fairly consistent between tests. The slight copper and nickel in the matrix of each graph was expected because our matrix originally consisted of SN100C, which contains 0.7 at % Cu and 0.05 at % Ni. The content of Ni in the hexagonal (Cu,Ni)₆Sn₅ IMC varies between 3.4 and 5.6 at %. The composition of the reinforcement particles stayed relatively constant at 10 at % nickel, because the reflow temperature that this model paste reached was far less than 50% of the absolute melting temperature (a typical lower limit for rapid solid state diffusion) of Cu-10Ni.

Within this composite solder mixture of high-melting Cu—Ni powder and low melting SN100C powder, a process that can be termed “liquid phase diffusion bonding” (LPDB) occurs, where the SN100C matrix alloy interdiffuses with and consumes the surface of the solid Cu—Ni reinforcement powder above the matrix liquidus temperature. The resulting alloy that comprises the majority of the matrix is hexagonal Cu_{5.5}Ni_{0.5}Sn₅, which has a higher melting temperature than the original matrix of SN100C.

For this composite solder technology, the term liquid-phase diffusion bonding or LPDB more accurately represents the phenomenon occurring within this composite microstructure between the melted solder alloy matrix and the slowly dissolving Cu-10Ni powders. Thus, a major portion of the bonding process actually involves rapid volume diffusion through the resulting intermetallic compound (IMC) phase that forms immediately upon melting of the solder alloy, rather than by the surface diffusion mechanism usually associated with solid-state sintering. It is quite interesting (see FIGS. 10a-10f) that after only 30 s at a peak reflow temperature of 250° C., the molten Sn-alloy matrix is converted almost completely into the ternary IMC, with only 4% of the original 30% of solder alloy remaining untransformed. This was accompanied by a loss of about 4% of the volume fraction of the Cu-10Ni alloy powder, which provided the excess Cu and Ni needed to accomplish this rapid growth of the IMC by what may be a volume diffusion process through the ternary IMC layer. Therefore, this example of the LPDB process refers to enhanced diffusion of Cu and Ni atoms from the solid Cu-10Ni reinforcement powder through a growing IMC layer to (eventually) consume the low-melting alloy matrix at a rather low temperature. For this system, it appears that a typical reflow temperature (250° C.) for SN100C solder is sufficient to encourage adequate solid-state diffusion to form a continuous conductive network throughout the composite solder joints.

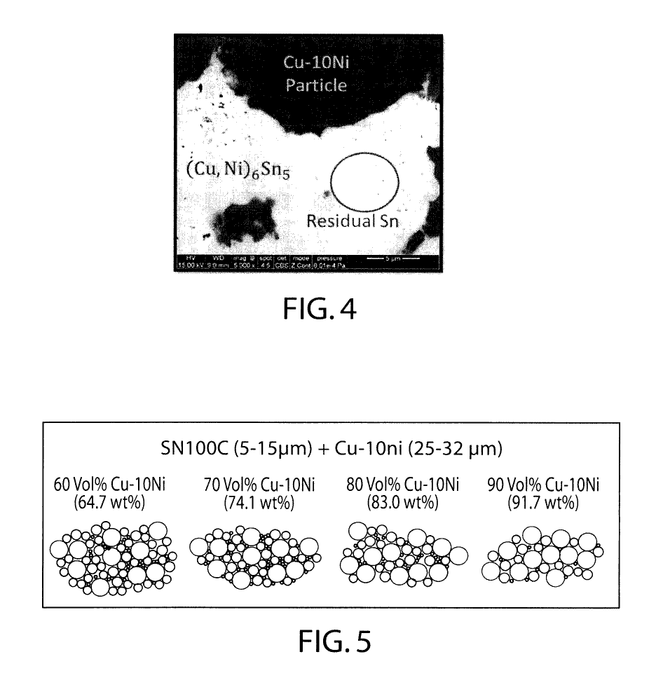

An innovative advantage of the composite solder paste system is that with each reflow cycle, more and more of the SN100C solder alloy transforms into the hexagonal (Cu,Ni)₆Sn₅ IMC, raising the final melting temperature of the system post-processing from 227° C. to about 400° C. and giving the solder the ability to withstand higher Joule heating. Also, it is apparent from the microstructures of FIGS. 9a-9f that there is the lack of cracking in the (Cu,Ni)₆Sn₅ IMC matrix or any significant Kirkendall voids. The image of FIG. 4 shows how the tin alloy diffuses into the surface of the reinforcement powder (the darkest regions of the microstructure), creating the stabilized hexagonal (Cu,Ni)₆Sn₅ phase.

Advantages, in addition to a lower reflow temperature, a shorter reflow time, a higher resulting melting temperature, and it being a lead-free/environmentally-friendly high temperature solder, are that the thermal expansion of the solder and most ceramic substrates are more equally matched and that the strength of the solder joint is theoretically increased. Estimates of the thermal expansion mismatch show a mismatch of 20-25 ppm/° C. between Pb-5Sn and alumina and a mismatch of only 5-10 ppm/° C. between Cu-10Ni and alumina [references 9,17,19]. Estimates of shear modulus for Pb-5Sn and Cu-10Ni show values on the order of 5 GPa and 50 GPa [reference 17], respectively [reference 15]. These estimated values are based on a “rule of mixtures” approach and remain to be experimentally tested.

### More Detailed Examples

The following examples were conducted to determine the effect of the volume fraction and particle size range of the Ni-containing powder (i.e. Cu-10 weight %) on solder joint porosity and solder joint composition. The performance of the solder pastes was determined by experimentation with reflow cycles on a hot plate using solder paste samples. The test setup used a boron-nitride coated stainless steel plate placed on a resistance-heated hot plate. A copper plate (substrate) was clamped by a stainless steel clamp fixture on the stainless steel plate to optimize the heating of the solder paste on the copper plate substrate. The setup was tested with various peak reflow temperatures along with peak reflow times described below.

Both single-sided and double-sided joints with Cu substrates were formed for analysis. In the case of the single-sided joints, the solder paste was spread on the copper plate substrate. In the case of double-sided joints, the experimental procedure was the same except that a second copper plate was placed on top of the solder paste residing on the lower copper plate.

### Volume Fraction Effect:

In initial testing, a double-sided joint was made from composite solder paste that was formulated from the powder blend of 70 vol. % Cu-10Ni and 30 vol. % SN100C solder alloy mixed with flux of the type described above (J-STD 002C RMA type of flux). This was given a reflow profile of 10 seconds at the peak temperature of 250° C.

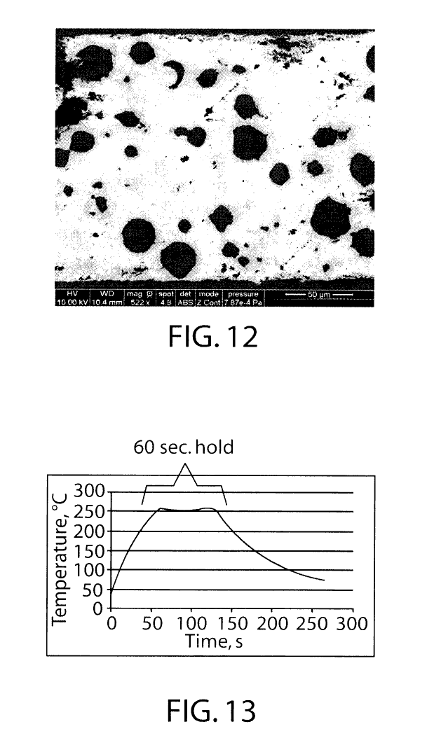

Next, a double-sided joint was made from a solder paste of 24 vol. % Cu-10Ni:76 vol. % SN100C powders and the flux with a reflow of 60 seconds at the peak temperature of 255° C. This second double-sided joint test using the solder paste of 24 vol. % Cu-10Ni:76 vol. % SN100C resulted in less solder joint porosity. The solder joint microstructure produced after reflow is seen in FIG. 12, revealing an illustrative example of the intended composite joint microstructure.

A re-test of the solder paste of 70 vol. % Cu-10Ni and 30 vol. % SN100C mixed with the flux but using a reflow profile (250° C. for 60 seconds) resulted in a large amount of residual flux residue remaining trapped in the solder joint. An EDS image (elemental mapping) showed large amounts of residual carbon, apparently from flux residue that prevented the molten Sn alloy powders from coalescing after melting and, thus, prevented successful joint formation. From this result, it was determined that there wasn't a viable path for the gaseous decomposition byproducts of the flux to escape during reflow due to the effect of an elevated paste viscosity from the continuous network of Cu-10Ni powder (at 70 vol. %) that blocked the passageways. Other micrographs of the same joint (not shown) indicated that porosity (spherical, gas-type bubbles) was also significant in this joint, as another indication of trapped thermal decomposition byproducts of the residual flux residue left in the reflowed joint.

As a result, three additional solder paste samples were blended to contain 13 vol. % Cu-10Ni, 26 vol. % Cu-10Ni, and 36 vol. % Cu-10Ni (the balance being the SN100C solder alloy powder) and mixed with the flux. The three pastes were each run with a reflow profile of 15, 30, and 60 seconds at the peak reflow temperature of 255° C. to make single-sided solder joints with which to test the effect of the powder blend ratio and time on joint porosity; namely, a higher vol. % of SN100C powder compared to Cu-10Ni powder in the composite paste mixture was hoped to have an effect on reducing the paste viscosity during reflow and, thus, the amount of retained porosity due to trapped flux residue after reflow. This effect could be achieved by a lowered composite paste viscosity by increasing the Sn alloy content since it would be liquid above 227° C., allowing for easier pathways for the flux residue to escape. This lower viscosity was intended to prevent gas-bubble-related voiding.

As just mentioned, three different powder blend ratios were used:

### 36 vol. % Cu-10Ni:64 vol. % SN100C,

### 26 vol. % Cu-10Ni:74 vol. % SN100C, and

### 13 vol. % Cu-10Ni:87 vol. % SN100C.

These powder blends correspond to 41 wt. % Cu-10Ni:59 wt. % SN100C; 30 wt. % Cu-10Ni:70 wt. % SN100C; and 16 wt. % Cu-10Ni:84 wt. % SN100C, respectively.

From analysis of the collection of SEM (montage) micrographs (not shown) of the solder joint microstructures produced in this way using a reflow profile of 255° C. for 60 seconds, it was concluded that increasing the amount of Sn-containing powders (SN100C) in the blend ratio helps to decrease overall porosity, a more important characteristic of joint quality that results from the reflowed paste, similar to FIG. 12. The least amount of solder joint porosity occurred when the paste powder blend contained 13 vol. % Cu-10Ni. Although not wishing to be bound by any theory, it appears that the tin alloy's being able to melt and reach the surfaces of the filler Cu-10Ni powders quicker, the tin alloy could completely engulf the reinforcement (filler) powders before the gaseous flux could become trapped by the isothermal solidification of the newly-formed bonding IMC by liquid-phase diffusion bonding (LPDB).

Solder joint microstructures made using the three solder pastes described above but using 15 seconds of reflow were evaluated. SEM images indicated the average area percent of each phase within the microstructure for all times measured with each vol. % of Cu-10Ni. For example, for 36 volume % Cu-10Ni, the IMC area (IMC matrix phase) of the joint was 45.7% of the total joint area after only 15 seconds of reflow. For 26 volume % Cu-10Ni, the IMC area of the joint was 46.2% of the total joint area after only 15 seconds of reflow. For 13 volume % Cu-10Ni, the IMC area of the joint was 31.7% of the total joint area after only 15 seconds of reflow. The total fraction of IMC phase after only 15 seconds of reflow was quite remarkable and was dependent on the amount of available Cu-10Ni interfacial area.

Moreover, as the Sn content of the paste blends was increased (due to less Ni—Cu powder), more IMC was formed with longer holds (e.g. 15 seconds and 60 seconds) at the peak reflow temperature. An increase in IMC was observed clearly, particularly for the samples with 36 vol. % and 13 vol. % of Cu-10Ni (pre-reflow volume % of Cu-10Ni powder).

Another observation found from these tests was that increasing the time of peak reflow does not reduce porosity. With longer reflow times, the solder paste only allows for more diffusion of the IMC, which largely increases the viscosity of the paste as it solidifies. In order for the flux to escape, the solder paste should have a lower viscosity upon initial reflow, which calls for the Cu-10Ni filler phase to be less than 50 vol. %, such from about 10 volume % to less than 50 volume % of the blend sans flux, in spite of the effect on solder joint electrical conductivity. The conductivity difference between the IMC and Cu-10Ni in the literature is actually relatively minor and that of the IMC is still within acceptable values. This lowered viscosity allows the flux to remain on the powders just until the tin melts and wets the solid powders. As soon as the wetting occurs, the residue is free to escape through the liquid tin. Therefore, increasing the amount of liquid phase upon reflow reduces joint porosity.

The composition of each solder joint phase produced using these paste blends stayed consistent with the intended joint composition, no matter what ratio of SN100C to Cu-10Ni was used, implying that the powder ratio does not affect the composition of the resulting phases.

### Particle Size Range Effect:

The particle size range of the Cu-10Ni powder was next investigated as to its effect, if any, on the porosity seen in the initial testing described above to produce a double-sided joint from composite solder paste that was formulated from the powder blend of 70 vol. % Cu-10Ni and 30 vol. % SN100C solder alloy and flux given a reflow profile of 10 seconds at the peak temperature of 250° C. This initial blend contained the same size of both powders. The Cu-10Ni powder was of Type 4 (25-32 μm), and the SN100C powder was also of Type 4 (25-32 μm).

In these additional tests, the size of each type of powder was tested for its effect on solder joint porosity of the composite paste. For this tests, the Cu-10Ni as-atomized powder was size classified to 20-38 μm and to 5-20 μm, which essentially matches the Type 4 and Type 6 size classifications for solder powder. Since SN100C powder was provided in both Type 4 (25-38 μm) and Type 6 (5-15 μm), this made it possible to produce paste samples called B, C, and D. Table 1 shows a summary of the different composite paste powder blends tested.

TABLE 1
Paste Blend Combinations Tested

| | Cu-10 Ni | | SN100C | | | |
|---|---|---|---|---|---|---|
| | Powder | | Powder | | | |
| Blend | Size | | Content | Size | | Content |
| A | 20-38 | μm | 13 vol % | 25-38 | μm | 87 vol % |
| B | 20-38 | μm | 13 vol % | 5-15 | μm | 87 vol % |
| C | 5-20 | μm | 13 vol % | 25-38 | μm | 87 vol % |
| D | 5-20 | μm | 13 vol % | 5-15 | μm | 87 vol % |

Each powder blend from Table 1 mixed with the above flux as a paste was spread onto a copper plate to form a single-sided solder paste joint wherein the copper plate was held in a stainless steel clamp fixture that was placed on the boron nitride-coated stainless steel plate residing on the hot plate surface to act as a heat sink in order to maintain a consistent hot plate temperature for reflow. A thermocouple was also clamped to the setup to monitor the temperature of the solder during the experimental runs. FIG. 13 shows the reflow profile for each run with a peak reflow temperature of 250° C. held for one minute. Each blend was tested twice for consistency.

The cross-sections of the resulting single-sided solder paste joints for Blends A and B, viewed under a scanning electron microscope (SEM) in backscatter mode indicated that Paste Blend B clearly seemed to produce lower porosity than Paste Blend A. Using quantitative metallography of at least fifteen (15) SEM images of the resulting joint from each reflow run, it was found that of at least fifteen (15) SEM images of the resulting joint from each reflow run, it was found that the images of Paste Blend A contain an average of 3.73 area % porosity and the images of Paste Blend B contain an average of 0.87 area % porosity. The SEM images also revealed a much smoother substrate bond when using the smaller particle size range Type 6 powder than when using the Type 4 powder. In addition, the intermetallic compound or IMC (Cu, Ni)₆Sn₅ seemed much more dispersed in the Sn matrix phase for the Type 6 powder.

When a double-sided solder paste joint was created using Paste Blend B, SEM images revealed that the interface remained connected and smooth. The porosity with the double-sided joint also remained low, averaging a porosity value of less than 1% of the image area.

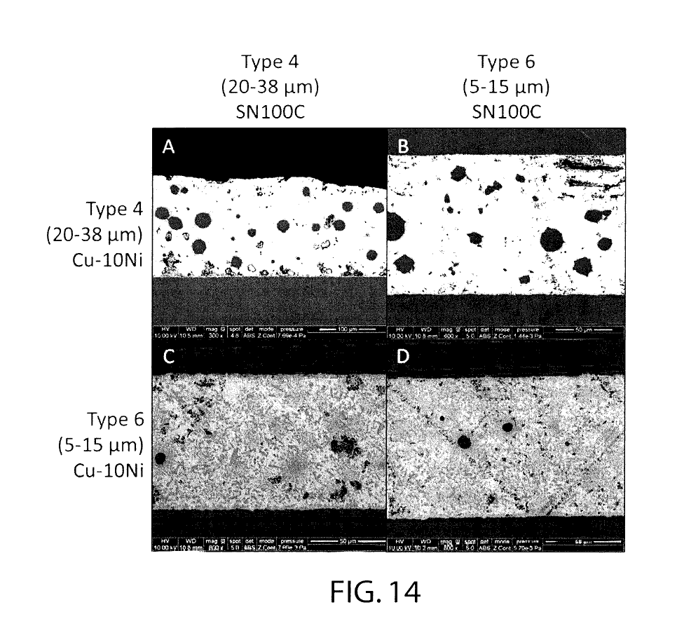

These results indicate that the smaller the SN100C powder, the less porous the joint. FIG. 14 shows the results of all four power paste blends. Images C and D of FIG. 14 also show a much more dispersed IMC. It is clear that changing the Cu-10Ni powder to the smaller size has a large effect on diffusion rate. Therefore, the preferred option for powder size in terms of porosity and diffusion rate appears to be Paste Blend D, which contains powder sizes of only 5-15 μm for both Cu-10Ni and SN100C powders; i.e. the particle size range of the Cu-10 Ni powder and the SN100C powder is substantially equal.

Energy dispersive spectroscopy (EDS) was performed on the solder joints in FIG. 14 to determine the consistency of the phase compositions with previous values from the composite paste. The compositions of the filler phase, the residual Sn, and the IMC surrounding the filler phase all remained consistent. Using the Type 6 powder paste blend, the desired ductile IMC phase that surrounds the tiller phase was observed.

Thus, in addition to the decrease in joint porosity, the smaller Type 6 powders sizes provided extra benefits in terms of spreading of the intermetallic compound that seems more dispersed in the joint made with the smaller powders. This quicker spread of the IMC should aid in the eventual goal of expanding the IMC across the entire joint interface. When the entire joint consists of a network of the nickel-modified IMC with possibly some residual pockets of Cu—Ni, the strength and ductility of the joint could improve. The composite solder paste joint will then take on the properties of a (Cu,Ni)₆Sn₅ matrix (Tₘ˜525° C.)² containing pockets of a stronger and more conductive Cu—Ni phase.

After these findings, the optimal ratio of Cu-10Ni to SN100C was calculated by determining the matching pre-reflow powder combination composition with that of an entire joint of Cu_{5.5}Ni_{0.5}Sn₅, this composition containing 50.12 at. % Cu, 4.58 at. % Ni, and 45.30 at. % Sn. By blending the paste to contain 66 vol. % Sn-alloy powder (SN100C) and 34 vol. % Cu-10Ni powder, the composition of the fully transformed solder joint should be 48.9 at. % Cu, 5.9 at. % Ni, and 45.2 at. % Sn.

From the above Examples, it is apparent that the dual-phase low melting solder blend (SN100C/Cu-10Ni) transforms to a composite solder joint for high temperature use. A preferred embodiment of the lead-free solder contains 70 volume percent Cu-10Ni powder blended with 30 volume percent SN100C powder, if a gas-based fluxing method is used on blended solder wafers to minimize porosity and trapped flux residue. Another preferred embodiment of the lead-free solder contains 13 volume percent Cu-10Ni powder blended with 87 volume percent SN100C powder to reduce or eliminate solder joint porosity. The resulting (Cu,Ni)₆Sn₅ IMC compositions of this solder system have an approximate 5 at. % content of Ni and showed no cracking due to the added solid solution nickel. There were no significant trends in area fraction or composition of the phases based on time or temperature. Due to this, the present invention provides for a suitable alternative lead-free high temperature solder with improved processing parameters.

Although the above Examples used a particular flux to fabricate the solder joints tested, the present invention is not so limited and envisions use of fluxes other than the flux described above, wherein the alternate flux is more volatile (i.e., is a gas-based flux like formic acid) and/or is more quickly removed during initial reflow such that flux selection alone, volume fraction selection alone, and/or particle size range selection alone, or in combination, provide option(s) that can be used to reduce and/or eliminate solder joint porosity.

The composite paste pursuant to the present invention is designed for rapid insertion into normal PCB assemblies wherein accommodating the switch to the solder paste pursuant to the invention would be nearly negligible in a commercial production setting. In addition, very similar processing parameters of those previously used in industry for Sn—Cu eutectic based paste could still be implemented successfully.

References, which are incorporated herein by reference:
1. Bader, S., W. Gust, and H. Hieber. “Rapid Formation of Intermetallic Compounds by Interdiffusion in the Cu—Sn and Ni—Sn Systems.” Acta Metall. Mater. Vol. 43, No. 1, pp. 329-337, 1995.
2. Chidambaram, Vivek, Jesper Hattel, and John Hald. “High-Temperature Lead-Free Solder Alternatives.” Microelectronic Engineering. 88 (2011) 981-989.
3. Corbin, S. F. “High-Temperature Variable Melting Point Sn—Sb Lead-Free Solder Pastes Using Transient Liquid-Phase Powder Processing.” Journal of Electronic Materials. Vol. 34, No. 7, 2005.
4. Corbin, S. F. and P. Lucier. “Thermal analysis of Isothermal Solidification Kinetics during Transient Liquid-Phase Sintering.” Metallurgical and Materials Transactions A. Volume 32A, April 2001-971.
5. Gayle, Frank W., Gary Becka, Jerry Badgett, Gordon Whitten, Tsung-Yu Pan, Angela Grusd, Brian Bauer, Rick Lathrop, Jim Slattery, Iver Anderson, Jim Foley, Alan Gickler, Duane Napp, John Mather, and Chris Olson. “High-Temperature Lead-Free Solder for Microelectronics.” JOM. June 2001, pp. 17-21.
6. Labie, Riet, Wouter Ruythooren, and Jan Van Humbeeck. “Solid State Diffusion in CuSn and Ni—Sn Diffusion Couples with Flip-Chip Scale Dimensions.” Intermetallics. 15 sn
7. Lumley, R. N. and G. B Schaffer. “The Effect of Solubility and Particle Size on LiquidPhase Sintering.” Scripta Materialia. Vol. 35, No. 5, pp. 589-595. 1996.
8. McCluskey, Patrick and Hannes Greve. “Transient Liquid Phase Sintered Joints for Wide Bandgap Power Electronics Packaging.” Pan Pacific Symposium Conference Proceedings. 11 Feb. 2014.
9. Mu, Dekui, Jonathan Read, Yafeng Yang, and Kazuhiro Nogita. “Thermal Expansion of Cu₆Sn₅ and (Cu,Ni)₆ Sn₅” Journal of Materials Research. Vol. 26, No. 20, Oct. 28, 2011.
10. Nogita, Kazuhiro. “Stabilisation of Cu₆Sn₅ by Ni in Sn-0.7Cu-0.05M Lead-Free Solder Alloys.” Intermetallics. 18 (2010) 145-149.
11. Nogita, Kazuhiro, Stuart D. McDonald, Hideaki Tsukamoto, Jonathan Read, Shoichi Suenaga, and Tetsuro Nishimura. “Inhibiting Cracking of Interfacial Cu₆Sn₅ by Nickel Additions to Sn-based Lead-Free Solders.” The Japan Institute of Electronics Packaging. Vol. 2, No. 1, 2009.
12. Nogita, Kazuhiro and Tetsuro Nishimura. “Nickel-Stabilised Hexagonal (Cu,Ni)₆ Sn₅ in Sn—Cu—Ni Lead-Free Solder Alloys.” Scripta Materialia. 59 (2008) 191-194.
13. Palmer, A. Mark, Nicole S. Erdman, and David A. McCall. “Forming high Temperature Solder Joints through Liquid Phase Sintering of Solder Paste.” Journal of Electronic Materials. Vol. 28, No. 11, 1999.
14. Park, M. S. and R. Arroyave. “Early Stages of Intermetallic Compound Formation and Growth during Lead-Free Soldering.” Acta Materialia 58 (2010) 4900-4910.
15. Qiao, X. and S. F. Corbin. “Development of Transient Liquid Phase Sintered (TLPS) Sn Bi Solder Pastes.” Materials Science and Engineering A283 (2000) 38-45.
16. Sheng Liu, Chao, Cheng En Ho, Cheng Sam Peng, and C. Robert Kao. “Effects of Joining Sequence on the Interfacial Reactions and substrate Dissolution Behaviors in Ni/Solder/Cu Joints.” Journal of Electronic Materials. Vol. 40, No. 9, 2001.
17. Siewert, Thomas, Stephen Liu, David R. Smith, and Juan carlos Madeni. “Properties of Lead-Free Solders Release 4.0.” Database for Solder Properties with Emphasis on New Lead-Free Solders through the National Institute of Standards and Technology and Colorado School of Mines. Colorado. 11 Feb. 2002.
18. Sweatman, Keith. “Another Chance for Tin-Copper as a Lead-free Solder.” APEX Special Issue. February 2005.
19. Sweatman, Keith, Tetsuro Nishimura, Stuart D. McDonald, and Kazuhiro Nogita. “Effect of Cooling Rate on the Intermetallic Layer in Solder Joints.” IPC APEX EXPO Proceedings.
20. Tsai, Tsung-Nan. “Thermal Parameters Optimization of a Reflow Soldering Profile in Printed Circuit Board Assembly: A Comparative Study.” Applied Soft Computing. 12 (2012) 2601-2613.
21. Ventura, Tina, Sofiane Terzi, Michel Rappaz, and Arne K. Dahle. “Effects of Ni Additions, Trace Elements, and Solidification Kinetics on Microstructure Formation in Sn-0.7Cu Solder.” Acta Materialia 59 (2011) 4197-4206.

Although certain illustrative embodiments of the present invention are described in detail above, those skilled in the art will recognize that various changes and modifications can be made therein without departing from the scope of the invention as set forth in the appended claims.

We claim:

1. A composite solder material that comprises a mixture of relatively low melting solder powder or solder-forming powder and a relatively high melting Ni-containing reinforcement powder that contributes Ni to a high temperature hexagonal (Cu,Ni)₆Sn₅ phase formed during reflow to stabilize the phase to room temperature.

2. The material of claim 1 wherein the reinforcement powder is present as a minority of the metallic powders present to reduce or eliminate solder joint porosity.

3. The material of claim 1 wherein the reinforcement powder is present from about 10% to less than 50% by volume of the mixture.

4. The material of claim 1 wherein the reinforcement powder is present as a majority of the metallic powders present.

5. The material of claim 1 wherein the reinforcement powder is present in an amount of about 50% to about 70% by volume of the mixture.

6. The material of claim 5 wherein the reinforcement powders are present in an amount of about 60% to about 70% by volume of the mixture.

7. The material of claim 1 wherein the particle size range of the Ni-containing reinforcement powder is substantially the same as or larger than the particle size range of the relatively low melting solder powder or solder-forming powder.

8. The material of claim 1 wherein the low melting point solder powder or solder-forming powder is selected from at least one of a low melting eutectic or near-eutectic Sn—Cu solder alloy, Sn—Cu—Ni solder alloy, and metallic Sn.

9. The material of claim 1 wherein the reinforcement powder comprises Cu—Ni alloy powder particles.

10. The material of claim 9 wherein the Cu—Ni alloy powder particles comprise Cu-5-15 weight % Ni.

11. The material of claim 1 wherein the Ni content of the reinforcement powder is substituted by an amount of Co.

12. The material of claim 1 that includes a flux to form a solder paste.

13. A solder joint comprising a stabilized high temperature hexagonal (Cu,Ni)₆Sn₅ phase as the matrix phase that bonds together Ni-containing reinforcement powder particles.

14. The joint of claim 13 wherein the reinforcement powder are present in amount to provide improved electrical conductivity of the solder joint between electrically conductive substrates.

15. The joint of claim 13 wherein the reinforcement powder comprises Cu—Ni alloy particles.

16. The joint of claim 13 that is free of a crack-promoting low temperature monoclinic Cu₆Sn₅ phase.

17. A method of making a solder joint, comprising liquid phase diffusion bonding the low melting solder or solder-forming powder and the Ni-containing reinforcement powder of claim 1 to form a stabilized hexagonal (Cu,Ni)₆Sn₅ matrix phase that bonds together the Ni-containing reinforcement powder particles.

18. The method of claim 17 wherein liquid phase diffusion bonding occurs during a reflow cycle.

19. The method of claim 18 wherein liquid phase diffusion bonding transforms, with each reflow cycle, more of the low melting solder or solder-forming powder to the hexagonal (Cu,Ni)₆Sn₅ matrix phase, raising the final melting temperatures of the post-processed solder joint.

20. The method of claim 17 that includes eliminating a crack-promoting low temperature monoclinic Cu₆Sn₅ phase in the solder joint matrix
